(19) United States
(12) Patent Application Publication
(10) Pub. No.: US 2008/0052416 A1
(43) Pub. Date: Feb. 28, 2008

(54) OBTAINING UTILITY DEVICES TO COMMUNICATE WITH A CONTROL UNIT IN A DATA PROCESSING SYSTEM

(75) Inventors: Juan A. Coronado, Tucson, AZ (US); Clint A. Hardy, Tucson, AZ (US); Jack N. Licano, Tucson, AZ (US); Brian S. McCain, Tucson, AZ (US); Beth A. Peterson, Tucson, AZ (US)

Correspondence Address: LAW OFFICE OF DAN SHIFRIN, PC - IBM, 14081 WEST 59TH AVENUE, ARVADA, CO, 80004, US

(73) Assignee: INTERNATIONAL BUSINESS MACHINES CORPORATION, Armonk, NY (US)

(21) Appl. No.: 11/466,682

(22) Filed: Aug. 23, 2006

(51) Int. Cl. G06F 15/177; G06F 15/16

(52) U.S. Cl. 709/250; 709/220

(57) ABSTRACT

In a data processing system, configured utility devices are designated in logical storage subsystems. The identification numbers of the designated utility devices are stored by a network interface. When a non-device specific command or query is received from a server by the interface, the interface obtains the ID of one of the utility devices and uses the utility device to address the command or query to the controller. Consequently, the overhead and delays associated with repeated command rejections due to unconfigured devices is substantially reduced.

### TECHNICAL FIELD

The present invention relates generally to enterprise data processing systems and, in particular, to communicating non-device specific commands and queries from a server to a controller.

### BACKGROUND ART

In large, enterprise data processing systems, S/390® or other hosts that attach to a storage control unit are required to send commands to specific device in a particular logical subsystem (LSS). These host commands may not even be relevant to a particular device, but the only way to run command from a host to the storage control unit is via a specific device. These devices must be configured and in a state that allows a command to be run (i.e.—ready, not in service mode or long busy, etc.)

In the IBM DS8000™ and DS6000™ storage servers, there is an additional external interface to a storage control unit. A server is connected to the storage controller through a network interface. The ESS network interface (ESSNI) uses query commands to obtain data associated with a logical subsystem as well. ESSNI uses the same System 390 architected command set. Consequently commands must be run to a particular volume (LSS and device). The storage system may be configured into logical storage subsystems (LSS), each of which is assigned, through a configuration process, one or more of the storage devices (such as up to 256 storage devices). Host commands are sent to a configured volume. Many commands also include a device address which the controller uses to process the command to access the desired device. Other commands, are non-device specific, such as those that are related to a logical subsystem. However, the hardware architecture may still require that a device be identified by the interface in order for it to be processed by the controller.

The identified device must be configured and in a state which allows a command to be run, such as “ready”, “not-in-service” or “long busy”. Because the server does not have the memory capability to store which volumes are in the correct state to accept I/O, to process non-device specific commands, queries and requests (collectively referred to herein as a “command”), the network interface will typically select a device at random or will always select the same device (such as device 0) to use to direct the command to the controller. And, because the S/390® architecture requires the command be issued on a valid device, if the device is not configured, the command is rejected, resulting in an error message. Successive retries may be attempted and, if the cause for rejection is temporary, a retry may succeed. However, if the device is not actually configured, the retries will be unsuccessful. Not only will the command not be issued, but the process by which the inevitable failure is reached is time consuming, thereby adversely affecting performance.

### SUMMARY OF THE INVENTION

The present invention provides for the designation of configured utility devices in logical storage subsystems in a data processing system. The identification numbers of the designated utility devices are stored in the network interface. When a non-device specific command or query is received by the server, the network interface obtains the ID of one of the utility devices and uses the utility device to address the command or query to the controller. Consequently, the overhead and delays associated with repeated command rejections due to unconfigured devices is substantially reduced.

### BRIEF DESCRIPTION OF THE DRAWINGS

FIG. 1 is a block diagram of a data processing system in which the present invention may be implemented; and

FIG. 2 is a flowchart of a process by which the present invention may be implemented.

### DETAILED DESCRIPTION OF THE PREFERRED EMBODIMENT

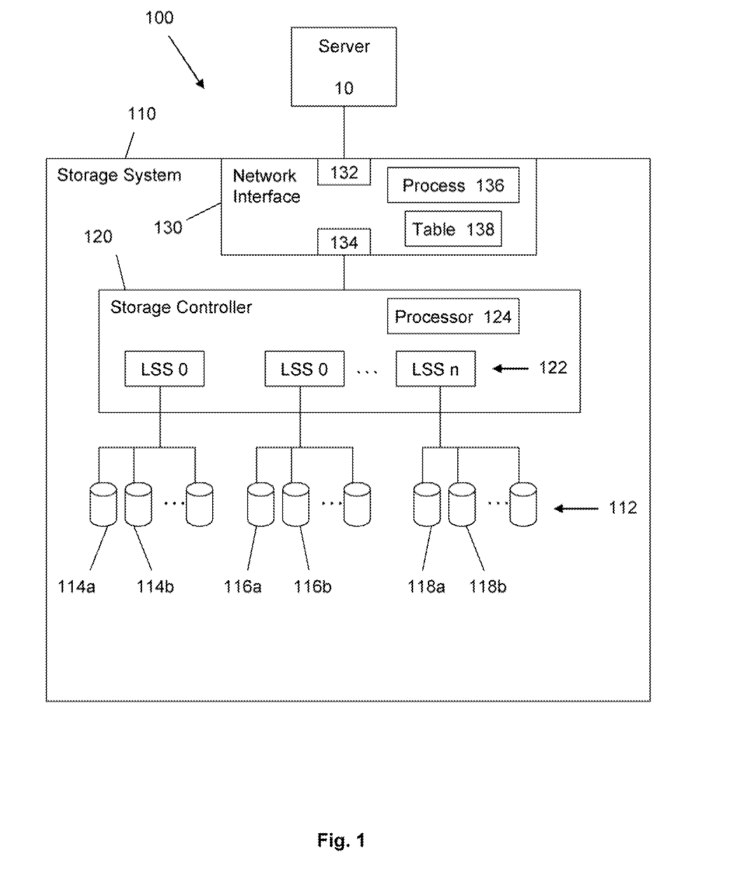

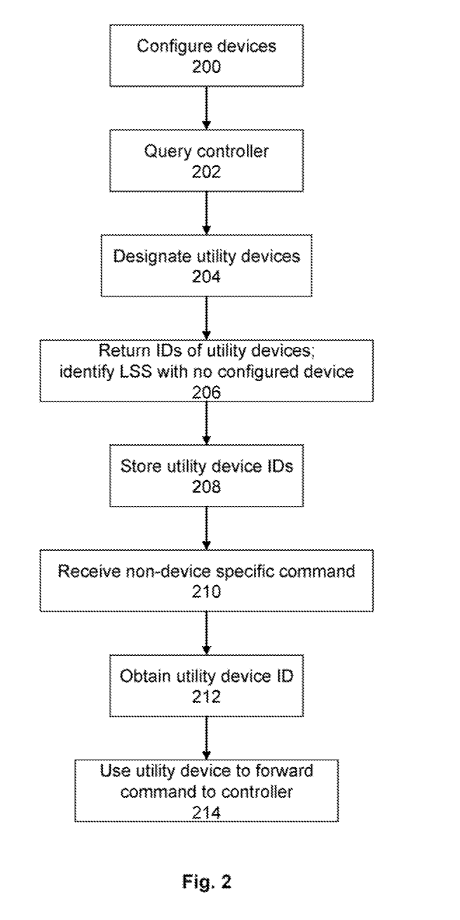

FIG. 1 is a block diagram of a data processing system 100 in which the present invention may be implemented. Although the invention is described herein in terms of a storage control unit or “controller” and logical storage subsystems (LSS), the present invention may be implemented with other devices as well. The system 100 includes a storage system 110, such as an IBM DS6000 or DS8000, having a storage controller, storage devices 112, such as hard disk drives (HDDs), and an interface 130, such as an IBM Enterprise Storage Server® Network Interface (ESSNI) or other network interface. A server 10 and a storage controller 120 are coupled to the interface 130 through appropriate connectors and circuitry 132 and 134, respectively, through which commands, queries, responses and other information are exchanged. The storage controller 120 may be configured with one or more logical storage subsystems (LSSs) LSS0, LSS1, . . . , LSSₙ, collectively referred to as LSS 122. Each LSS is assigned one or more storage devices 112. Referring also to the flowchart of FIG. 2, the storage devices 112 are configured to the LSSs (step 200). Although preferably each LSS 122 will have at least several storage devices 112 configured, an LSS 122 may have one or even no configured storage device 112. A process 136 in the interface 130 is programmed to query the storage controller 120 by transmitting a command through the connector 134 to obtain information about the LSSs 122 and the configured storage devices 112 (step 202). In each LSS 122, one, or preferably two, storage devices 112 may be designated, such as by a processor 124 in the storage controller 120, as “utility” devices (step 204). In FIG. 1, two devices 114ₐ, 114_{b} have been designated in LSS0, two 116ₐ, 116_{b} in LSS1 and two 118ₐ, 118_{b} in LSSₙ. The identification numbers (IDs) of the designated utility devices are transmitted by the storage controller 120 to the network interface 130 (step 206) and stored by the network interface 130, such as in a table 138 (step 208). If, as may happen, there are no configured storage devices in an LSS, the response by the storage controller 120 to the interface query will so indicate (step 206).

During operation of the system 100, if the server 10 sends a device specific command or query to the storage controller 120, the network interface 130 will forward the command or query to the controller 120 with the appropriate device address or ID. If the server 10 sends a non-device specific command or query to the storage controller 120 (step 210), the network interface 130 obtains the ID of a utility device (114ₐ or 114_{b} in LSS0, 116ₐ or 116_{b} in LSS1 and 118ₐ or 118_{b} in LSSₙ) from the table 138 (step 212). The network interface 130 may then use the utility device to address the command or query to the controller 120 for processing (step 214).

In accordance with the present invention, each LSS 122 will preferably have at least one device 112 which the interface 130 “knows” has been configured as a utility device and is available for use in addressing non-device specific commands and queries to the controller 120. Consequently, repeated command rejections due to unconfigured devices, and the overhead and delays associated therewith, are substantially reduced.

It is important to note that while the present invention has been described in the context of a fully functioning data processing system, those of ordinary skill in the art will appreciate that the processes of the present invention are capable of being distributed in the form of a computer program product of a computer-readable medium having computer-readable code comprising instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for executing non-device specific server commands in a storage control unit.

What is claimed is:

1. A method for executing non-device specific host commands in a storage control unit, comprising:
a) providing a network interface between a server and a storage control unit;
b) configuring a plurality of devices in a logical storage subsystem (LSS), each device having a device identification (ID);
c) designating a first device in the LSS as a utility device;
d) storing the ID of the first utility device in the network interface;
e) receiving a query command from the server;
f) determining if the query command is device-specific;
g) if the query command is not device-specific, obtaining the first utility device ID; and
h) sending the non-specific commands to the storage control unit using the first utility device.

2. The method of claim 1, further comprising:
designating a second device in the LSS as a second utility device;
storing the ID of the second utility device in the network interface;
receiving a query command from the server;
determining if the query command is device-specific;
if the query command is not device-specific, obtaining the first and second utility device IDs; and
sending the non-specific commands to the storage control unit using one of the first and second utility devices.

3. The method of claim 1, further comprising performing steps b) through d) for each of a plurality of LSSs.

4. A network interface between a server and a controller, comprising:
a first interface through which commands are received from a server;
a second interface to which a storage server is attached, the storage server configured with one or more logical storage subsystems (LSSs), each LSS assigned to one or more attached storage devices, each storage device having an identification number (ID);
a processor programmed to:
transmit a query to the storage controller seeking the ID of any storage devices designated by the storage controller as a utility device, including a first utility device; and
receive a response to the query; and
a table in which the ID of any storage device designated as a utility device is stored;
the processor further programmed to:
determine if a query command received from the server is device-specific;
obtain from the table the ID of the first utility device if the query command is not device-specific; and
forward the non-device-specific command to the storage control unit using the ID of the first utility device, whereby the command is executed by the storage controller.

5. The network interface of claim 4, wherein the network interface comprises an Enterprise Storage Server Network Interface (ESSNI).

6. The network interface of claim 5, wherein two devices in each LSS are designated as utility devices.

7. A data storage system, comprising:
a network interface comprising:
a first interface;
a process;
a data table; and
an interface through which commands are received from a server;
a storage controller comprising a processor;
a plurality of logical storage subsystems (LSS) configured by the storage controller;
a plurality of configured storage devices attached to the plurality of LSSs, each storage device having an identification (ID);
the processor programmed to designate a first storage device in at least one of the plurality of LSSs as a utility device; and
a table, associated with the network interfacer configured to store the ID of each utility device and the LSS to which it is configured;
the process operable to:
determine if a query command received from the server is device-specific;
obtain from the table the ID of a first utility device if the query command is not device-specific; and
transmit the non device-specific query command to the storage controller for processing using the first utility device.

8. The storage control unit of claim 7, wherein:
the process is further operable to designate a second device in the at least one LSS as a second utility device;
the table is further configured to store the ID of each second utility device; and
the processor is further programmed to, if the received query command is not device-specific, obtain the first and second utility device IDs.

9. The storage control unit of claim 7, wherein the network interface is an Enterprise Storage Server Network Interface (ESSNI).

10. A computer program product of a computer-readable medium usable with a programmable computer, the computer program product having computer-readable code embodied therein for executing non-device specific server commands in a storage control unit, the computer-readable code comprising instructions for:
a) providing a network interface between a server and a storage control unit;
b) configuring a plurality of devices in a logical storage subsystem (LSS), each device having a device identification (ID);
c) designating a first device in the LSS as a utility device;
d) storing the ID of the first utility device in the network interface;
e) receiving a query command from the server;
f) determining if the query command is device-specific;
g) if the query command is not device-specific, obtaining the first utility device ID; and
h) sending the non-specific commands to the storage control unit using the first utility device.

11. The computer program product of claim 10, wherein the computer-readable code further comprises instructions for:
designating a second device in the LSS as a second utility device;
storing the ID of the second utility device in the network interface;
receiving a query command from the server;
determining if the query command is device-specific;
if the query command is not device-specific, obtaining the first and second utility device IDs; and
sending the non-specific commands to the storage control unit using one of the first and second utility devices.

12. The computer program product of claim 10, wherein the computer-readable code further comprises instructions for performing steps b) through d) for each of a plurality of LSSs.
